(19) United States
(12) Patent Application Publication
(10) Pub. No.: US 2017/0032450 A1
(43) Pub. Date: Feb. 2, 2017

(54) VIRTUAL MARKETPLACE

(71) Applicant: Trusper, Inc., Santa Clara, CA (US)

(72) Inventors: Jack Shilian Jia, Los Altos Hills, CA (US); Aya Takeuchi, San Mateo, CA (US)

(21) Appl. No.: 14/812,690

(22) Filed: Jul. 29, 2015

(51) Int. Cl. G06Q 30/06; G06Q 50/00; G06Q 10/08

(52) U.S. Cl. CPC G06Q 30/0635; G06Q 30/0613; G06Q 30/0609; G06Q 10/083; G06Q 50/01

(57) ABSTRACT

Aspects extend to methods, systems, and computer program products for providing a digital marketplace. A digital marketplace includes a merchant manager tier, a role tier, and a marketplace tier. Components across the three tiers interoperate to permit users to create, modify, and access virtual stores. Users can include items in their virtual store based on their interests and experiences. Users can also promote items for different brands and share in revenue from sales of the promoted items. A users interests and experiences changes, the use can corresponding change promoted items offered for sale through their virtual store. Virtual stores can include tips on brands or items. As such, each user's virtual store can be a dynamic representation of interests and experiences of the user at a particular time.

### CROSS-REFERENCE TO RELATED APPLICATIONS

Not applicable.

### BACKGROUND

1. Field of the Invention

This invention relates generally to the field of social networking, and, more particularly, to a virtual marketplace integrating and presenting products and product related tips.

2. Related Art

Brands can use any of variety of mechanisms to offer their products for sale, including offering products for sale directly to consumers through physical store locations and/or an online presence (e.g., e-commerce website), offer products for sale through another retailer's one or more physical locations and/or an online presence, through multi-level marketing (MLM) arrangements, etc.

Depending on brand size and marketing, a direct sales approach may be inefficient for a product. For example, the brand owner may lack the budget for advertising and/or marketing for a product, the ability to create an online presence, open physical store locations, etc. As such, consumers are provided little, if any, information about the product. Some brand owners may offer products for sale through other online resources (e.g., 3^{rd} party e-commerce sites). However, these online resources still provide limited information to potential consumers. As a result, consumers may be hesitant to purchase the product based on limited available information.

Some brand owners turn to other retail operations to provide legitimacy for their products based on the reputation of the retailer. The reputation of the retailer may give consumers a level of comfort with the product. Consumers may know that in the past the retailer has only offered quality products and may assume that any new products are of similar quality. While a retailer can give a brand exposure, the financial terms of such an arrangement are usually more beneficial to the retailer than the brand owner. For example, a retailer may take up to 80% of revenue for any products it sells, leaving no more than 20% of the revenue for the brand owner.

Multi-Level marketing arrangements typically have a more even distribution of revenue between MLM representatives and a brand owner selling products through an MLM arrangement. In many MLM arraignments, revenue splitting is closer to 50/50. Further, MLM arrangements are able to leverage crowds (the MLM representatives) for marketing and sales. However, MLM arrangements suffer from various stigmas, including lack of transparency, lack of objective representations about products (i.e., self-interested representatives with no checks and balances), etc. Due to these stigmas, many consumers refuse to purchase products from MLM representatives under any circumstances (even if a product might otherwise meet their needs). Additionally, MLM representatives often only represent a single brand, are geographically constrained, and have limited expansion opportunities (e.g., just friends and family).

Further, for both traditional retailers and MLM representatives, sourcing products is time consuming, requires physical negotiation, often requires prior relationships, and requires exclusivity and sales quotas.

Due to downsides with these various different sales arrangements, products for new and emerging brands can have difficulty generating revenue.

### BRIEF DESCRIPTION OF THE DRAWINGS

The specific features, aspects and advantages of the present invention will become better understood with regard to the following description and accompanying drawings where:

FIGS. 1A and 1B illustrate an example computer architecture that facilitates providing a virtual market place.

FIGS. 2A and 2B illustrates am example computer architecture that facilities maintaining and presenting virtual stores.

FIG. 3 illustrates a flow chart of an example method for creating a virtual store.

FIGS. 4A-4D depict user interface screens used by a promoter.

FIGS. 5A-5B depict additional user interface screens used by a promoter.

FIGS. 6A-6B depict further user interface screens used by a promoter.

FIGS. 7A-7D depict a process flow for purchasing products from a product feed.

FIGS. 8A-8D depict product detail user interface screens.

FIG. 9 depicts different ways a new product can be added.

FIG. 10 depicts various inventory details.

FIG. 11 depicts a purchase flow for direct purchase.

FIG. 12 depicts a purchase flow for co-listing.

FIG. 13 depicts a purchase flow for bulk-buying.

FIG. 14 depicts various different revenue models.

FIG. 15 depicts a payment flow for a direct purchase.

FIG. 16 depicts a payment flow for a co-listed purchase.

FIG. 17 depicts a payment flow for a promoter bulk-buy from brands.

FIG. 18 depicts a payment flow for bulk buy sales.

FIG. 19 illustrates another example computer architecture that facilitates providing a virtual marketplace.

### DETAILED DESCRIPTION

The present invention extends to methods, systems, and computer program products for providing a virtual market place.

Implementations may comprise or utilize a special purpose or general-purpose computer including computer hardware, such as, for example, one or more processors and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the define subject matter defined is not necessarily limited to the described features or acts described above.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Devices can have touch screens as well as other I/O components.

Aspects of the invention can also be implemented in cloud computing environments. In this description, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

It is further noted that, where feasible, functions described herein can be performed in one or more of: hardware, software, firmware, digital components, or analog components. For example, one or more application specific integrated circuits (“ASICs”) can be programmed to carry out one or more of the systems and procedures described herein. Certain terms are used throughout the following description to refer to particular system components. As one skilled in the art will appreciate, components may be referred to by different names. This document does not intend to distinguish between components that differ in name, but not function.

System Architecture

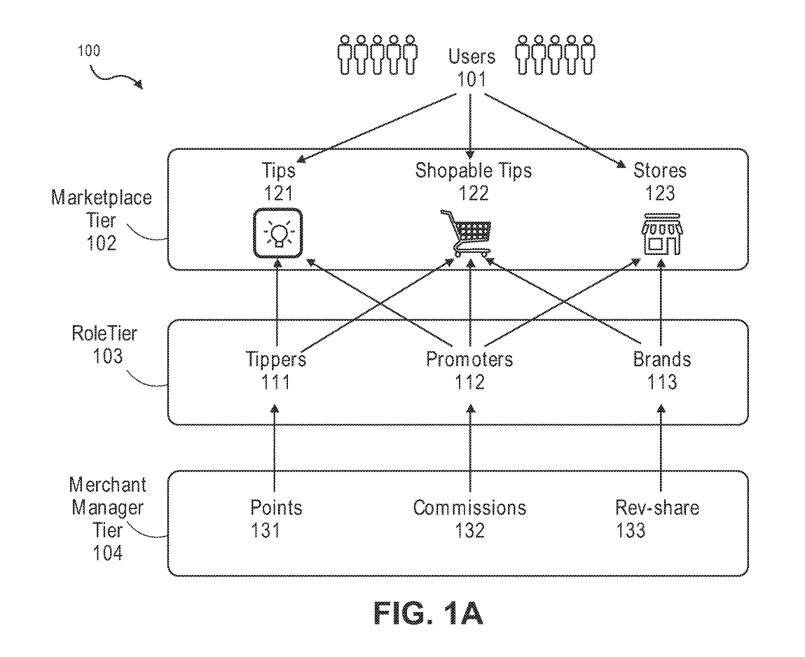

FIG. 1A depicts an example computer architecture 100 for providing a virtual market place. Computer architecture 100 can be included in a social media networking infrastructure. Referring to FIG. 1A, computer architecture 100 includes three tiers: marketplace tier 102, role tier 103, and merchant manager tier 104. Each of the tiers can be implemented on computer-hardware devices, in firmware, or on other circuitry.

Users 101 (e.g., of a social networking system), can interact with components across the three tiers. Components and data within marketplace tier 102, role tier 103, and merchant manager tier 104 can be connected to (or be part of) a network, such as, for example, a Local Area Network (“LAN”), a Wide Area Network (“WAN”), and even the Internet. Accordingly, components and data within marketplace tier 102, role tier 103, and merchant manager tier 104 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

In general, marketplace tier 102 provides user facing data. Users 101 can interact with the user facing data to gain information, make purchases, etc. As depicted, marketplace tier 102 includes tips 121, shoppable tips 122, and stores 123.

In general, role tier 103 represents different roles a user can take within a virtual marketplace. Role tier 103 includes tippers 111, promoters 112, and brands 113. A user can take on more than one role within a virtual marketplace. For example, a user can provide tips about some items and/or promote other items. Thus, tippers 111, promoters 112, and brands 113 can also be included in users 101.

In general, merchant manager tier 104 provides mechanisms for settling transactions. As depicted, merchant manager tier 104 includes points 131, commissions 132, and revenune sharing 133.

Elements within the three tiers can interact to facilitate a virtual market place. Tippers 111 can configure tips 121 or shoppable tips 122 within marketplace tier 102. Promoters 112 can configure tips 121, shoppable tips 122, and stores 123 within marketplace tier 102. Brands 113 can configure shoppable tips 122 and stores 123 within marketplace 102.

Shoppable tips can be used to educate and market products. Some shoppable tips are lifestyle tips that make use of products. The effectiveness of shoppable tips can be much more effective (on the order of 10×-20×) than traditional brand generated advertisements.

FIG. 1B depicts another view of computer architecture 100 for providing a virtual market place. As depicted, stores 123 can be provider for various brands, distributors, wholesalers, etc. 113A, 113B, and 113C. Stores 123 can also be provided for brand-direct retailers, promoters, etc. 112A, 112B, 112C, and 112D. Shoppers 142 (users 101) can use social networks 141 to access stores 123.

As such, on a per user basis, marketplace tier 102 (e.g., through a store application or seller application) can (by leveraging elements of role tier 103 and merchant manager tier 140) provide fully functional eCommerce operations including Customer Relationship Management (CRM), order and inventory management, reviews and ratings, customer service, messaging, etc. The eCommerce operations, allow any user, even with little professional training, to run a virtual store 123 in marketplace tier 102. The virtual store 123 can represent products from a plurality of different brands. The user can then leverage their knowhow and social influence to make marketing and sales happen.

Trusted Social

As such, aspects of the invention include a trusted social network that adds value by sharing information that is both of interest to a user (e.g., based on needs, preferences, and time and place) and is from trusted sources (e.g., friends). Shared information can relate to life tips, including tips on: beauty, health & fitness, family & kids, food & drink, home & garden, relationships, travel, fashion, entertainment, sports, auto, arts, education, pets, technology, offers and deals, for hire, help wanted, etc. Tips associated with the trusted social network can be created (as well as presented) through a program that provides an interface to the trusted social network.

The program can provide a user-interface for a user to submit tips to and view tips from the trusted social network. The program can be run on a computing device, such as, a mobile phone. In some aspects, the application program (or “app”) is used to present the user interface and handle interactions with the trusted social network. In other aspects, web based constructs are used to present the user interface and handle interactions with the trusted social network through a web browser.

Tips can include videos, pictures, audio, products and notes about knowhow and information on daily needs. Tips can vary in scope and can be shared among trusted friends and service professionals. Tips can be for friends, can be self-tips, or can be public-tips. In some aspects, tips can be created in a short amount of time (e.g., 2-5 minutes).

Aspects of the invention can provide a market place of tips for home life. Content and users can be bootstrapped for viral growth with experts in different categories.

By factoring social and interest characteristics of a user, content/tips that a user would like to consume can be predicted at any given moment. Related Tips can be displayed to users by weighing social norms, contexts, location and historical interests. A matching engine can dynamically weigh in these factors and change what users see. The matching engine can observe, learn and adapt.

Users can configure settings so that lower quality tips are filtered from presentation. The quality can varied depending on if a tip is from a friend or is a public tip. A user may be willing to view lower quality tips from friends. On the other hand, the user may not be willing to view lower quality public tips. Lower quality tips can be flagged.

Virtual Stores

In some aspects, promoters (e.g., promoters 112) create shoppable tips (e.g., shoppable tips 122) or link existing tips associated with a product to a location where the product can be purchased. Promoters can have financial arrangements (managed in merchant manager tier 104) with brand owner's (e.g., brands 113). When a promoter's activities result in the sale of a product, the brand owner can give the promoter a commission.

Promoters can promote one or more different products for one or more different brand owner's and can have a financial arrangement (managed in merchant manager tier 104) with each of the one or more different brand owner's. Promoted products and associated tips can be presented to other users of a social media platform through a virtual store. When a sale results from a user's interaction with the promoter's virtual store, the promotor can receive a commission from the relevant brand owner.

Promoters can be sales representatives, brand advocates, bloggers, social media users, etc.

Brands can be manufacturers, merchants, wholesalers, retailers, etc.

A virtual store can be used to promote and sell essentially any number of products (1−N). In one aspect, a “micro store” is used to promote and sell a relatively smaller number of (e.g., a few) products. A virtual store can also be targeted to essentially any number of consumers (1−N). In one aspect, a micro store store is targeted to a relatively smaller number of (e.g., a few dozen) consumers having a potential interest in the relatively smaller number of products being sold at the micro store.

For example, a promoter can create and manage a micro store of five products for three dozen consumers. The micro store can be managed from virtually anyway, at any time, and on a variety of different devices. The promoter can used their social influence to market and sell the products from their micro store.

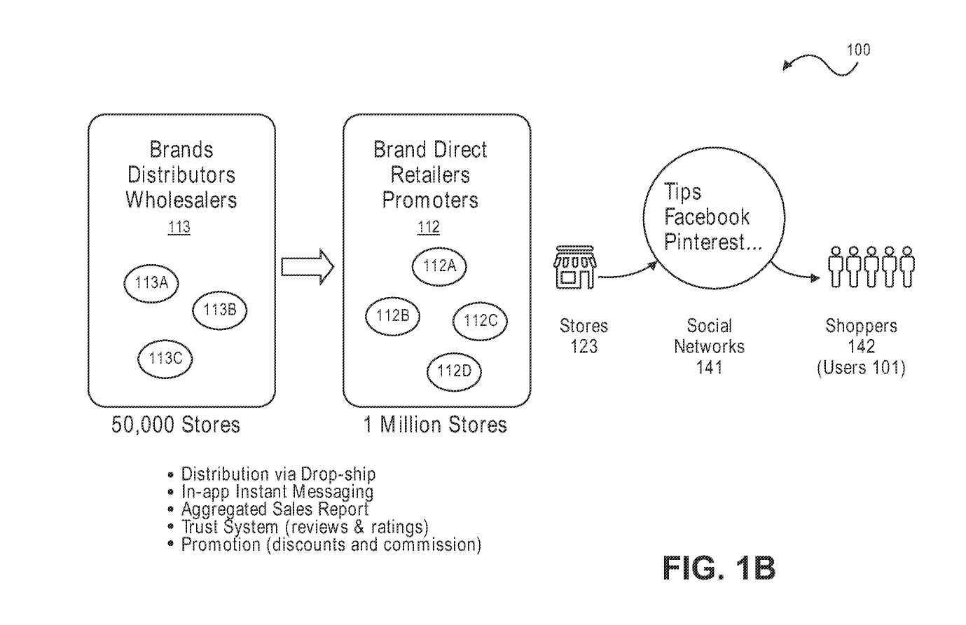

FIGS. 2A and 2B illustrates an example computer architecture 200 that facilities maintaining and presenting virtual stores. Each of the components depicted in computer architecture 200 can be implemented on computer-hardware devices, in firmware, or on other circuitry. Referring to FIG. 2A, computer architecture 200 includes digital marketplace 202, which further includes login module 214, store database 216, store configuration module 217, and user database 219. Digital marketplace 202 and included modules can be connected to (or be part of) a network, such as, for example, a Local Area Network (“LAN”), a Wide Area Network (“WAN”), and even the Internet. Accordingly, digital marketplace 202 and included modules as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

In general, login module 214 is configured to receive user credentials and log a user into digital marketplace 202. Login module 214 can compare user credentials to user database 219 to determine if the user credentials are for a valid user. User database 219 can store credentials, profile information, etc. for users of digital marketplace 202 (which can be part of a social media network).

Store configuration module 217 is configured to configure virtual stores for users in response to user input (e.g., selecting items to add to a store, identifying items to remove from a store, adjusting item prices, adding item tips, etc.). Store data (e.g., state) representing a virtual store can be stored at and accessed from store database 216. Each user of digital marketplace 202 can have virtual store representing their interests and experiences as of the time the store was configured. As a user's interests and experiences change, the user can use store configuration module 217 to change their store. For example, a user can change items that are for sale, a user can change tips associated with items, a user can provide different promotions for items or brands, etc. Store data representing changes can be stored at store database 216. As such, each user's virtual store can be a dynamic representation of interests and experiences of the user at a particular time.

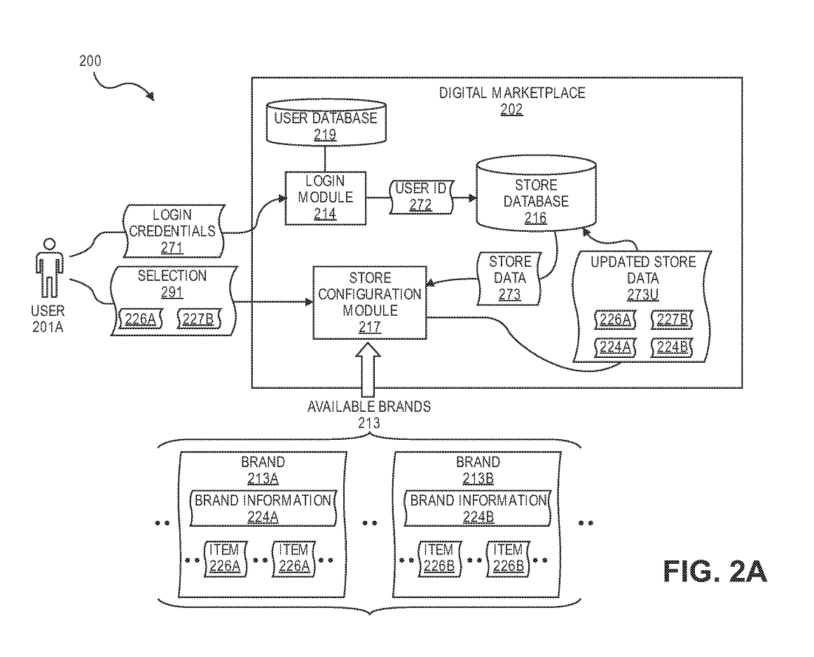

FIG. 3 illustrates a flow chart of an example method 300 for creating a virtual store. Method 300 will be described with respect to the components and data of computer architecture 200.

Method 300 includes an act of accessing an identifier for a user of the digital marketplace (301). For example, user 201A can submit login credentials 271 to login module 214. Login module 214 can refer to user database 219 to determine that login credentials 271 correspond to user 201A. In response, login module 214 can access user ID 272 (a user ID corresponding to user 201A). Login module 214 can submit user ID 272 to store database 216. In response, store database 216 can return store data 273 to store configuration module 217. Store data 273 can include basic information for setting up a new virtual store. Alternately, store data 273 can contain data for a previously established store (e.g., one or more items for sale, prices, item tips, etc.)

Method 300 includes an act of establishing a virtual store for the user within the digital marketplace, the virtual store associated with the identifier (302). For example, store configuration module 217 can use store data 273 to establish a virtual store for user 201A. The store can be an empty virtual store (if user 201A is setting up a new virtual store) or can include information previously configured for a virtual store (e.g., one or more items for sale, prices, item tips, etc.)

Method 300 includes accessing a plurality of brands having items that can be sold in the digital marketplace (303). For example, in response to user commands from user 201A, use configuration module 217 can access available brands 213. As depicted, available brands 213 include brands 213A, 213B, etc. Each brand can include brand information and one or more items offered by the brand. For example, brand 213A includes band information 224A and items 226A, 227A, etc. Likewise, brand 213B includes brand information 224B and items 226B, 227B, etc. Available brands 213 can be presented to user 201A through a user interface.

Method 300 includes receiving a selection of a plurality of items the user desires to promote to other users, the plurality of items representative of interests and experiences of the user at the time the selection is received, the plurality of items including at least one item from a first brand and at least one item from a second brand, the first brand and the second brand included in the plurality of brands (304). For example, user 201A can send selection 291 to digital marketplace 202. Store configuration module 217 can receive selection 291 from user 201A. Selection 291 includes items 226A and 227B that user 201A desires to promoted to other users of digital marketplace 202. Items 226A and 227B are representative of interests and experiences of user 201A at the time user 201A sent selection 291.

Method 200 includes integrating the plurality of items into the virtual store to offer the plurality of items for sale at the virtual store, integrating the plurality of items including integrating brand information for both the first brand and the second brand for presentation at the virtual store such that the plurality of items appear to be for sale by the user (305). For example, store configuration module can integrate brand information 224A and item 226A and brand information 224B and item 227B into updated store data 273U. Updated store information 273U can subsequently be used to present a virtual store that offers items 226A and 227B as being for sale by the user 201A.

Subsequent to sending selection 291, user 201A can further interact with store configuration module to make additional changes store data 273U for the virtual store. User 201A can change store data 273U by removing one or more items from the virtual store and/or adding one or more other items to the virtual store. User 201A can choose to change the virtual store at essentially any time due to changes in interest and experiences. User 201A can change the virtual store at virtually any frequency, even multiple times per hour if so desired. As such, the virtual store can be a dynamic representation of interests and experiences of user 201A at any particular time.

In one aspect, store data 273U is store data for a micro store that is to include just items 226A and 227B. In other aspects, store data 273U is for a virtual store that is to include a number of other items in addition to items 226A and 227B. User 201A can then use their social influence to market and sell items 226A and 227B (and, when appropriate, any of the number of other items)

Turning to FIG. 2B, user 201B can login to digital marketplace 202. User interface 276 and browser module 218 can interoperate to present data from digital marketplace 202 to user 201B and receive commands from user 201B directed to digital market place 202. User 201B can browse stores and/or users at digital marketplace 202. User 201B can enter commands that cause browse module 218 to access user/store data 281 from store database 216 and user database 219. In general, user/store data 281 is a mix of user and virtual store data for one or more users. For example, user/store data 281 can include a profile page for user 101A that includes a link to user 101's virtual store, a list of links to virtual stores for other different users, etc. User/store data 281 can be presented as marketplace data 282 at user interface 276.

User 201B can submit store selection 283 to select a particular virtual store from within market place data 282. Store selection 283 can be a link to virtual store 274 (the virtual store for user 201A). The link can be associated with and/or included in a shoppable tip (e.g., on user 201A's profile page). User 201B may select the link to virtual store 274 due to the social influence of user 201A (e.g., based on general knowledge of user 201A, based on the content of the shoppable tip, etc.) Browse module 218 can use store selection 283 to select updated store data 273U from store database 216. Browse module 218 can process updated store data 273U to generate virtual store 274. Browse module 218 can present virtual store 274 at user interface 276. As depicted, virtual store 274 includes brand information 224A and item 226A and brand information 224B and item 227B. Virtual store 274 can also include tips related to item 226A and/or item 227B.

In one aspect, virtual store 274 is a micro store that user 101A uses to promote and offer for sale just items 226A and 227B. In another aspect, user 101A uses virtual store 274 to promote and offer for sale a number of other items in addition to items 226A and 227B.

Browse module 218 can link to other modules in merchant manger tier 104 (not shown). If user 201B selects an item for purchase from virtual store 274, browse module 218 can interoperate with the other modules to start a purchase workflow. When a purchase is complete, additional modules in merchant manager tier 104 can initiate one or more of: a distribution of points to user 201A, payout of a commission to user 201A, or revenue sharing between user 201A and a brand. Further modules, in merchant manager tier 104 can initiate a workflow for order fulfillment of a purchased item.

Virtual stores from a plurality of different promoters can be combined and made available to users through a social networking infrastructure to provide a virtual marketplace. Promoters can also be as users. For example, a promoter may promote some products and also be open to purchasing products from other promoters.

In a mobile environment, a virtual market place provided via an application (e.g., a smart phone “app”) transcends space, time, and scale. For example, a brand located in New York can be promoted by a promoter in California 24 hours a day, Seven days a week. A promoter can be anyone that promotes the brand at any scale, from users having only a few followers to users having millions of followers. The use of a mobile application allows promoters to work from anywhere at any time.

Promoter User Interface

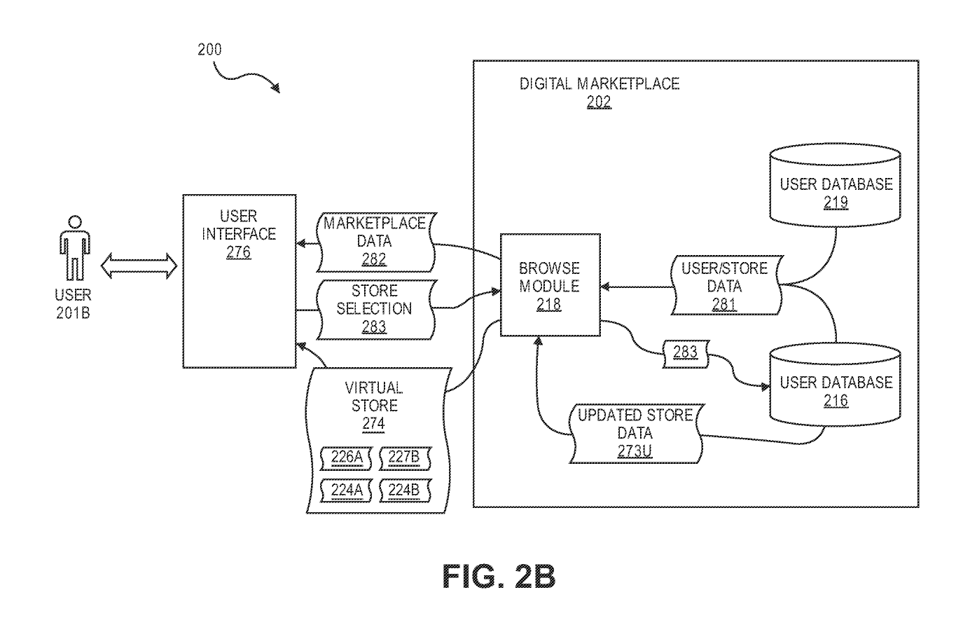

FIGS. 4A-4B depict user interface screens used by a promoter. FIG. 4A depicts user interface screen 401A. User interface screen 401A presents user interface controls for selecting functionality available to a promoter/seller (e.g., a promoter 112). The selectable functionality includes user interface controls for messages/news 411, manage a (virtual) store 412, manage orders 413, see sales history 414, manage customers 416, and manage finance 417.

Messages/news 411 can provide Text-based p2p communication like Skype/Messanges/Wechat. A List-view inbox can contain contains past & current notifications/messages/conversations from a social media network infrastructure or system, customers or automated system, newest conversation being on top. Ability to click on customer's profile from chat thread/room and go directly to the Customers page and see his/her information.

Customers 418 can sort customers by different filters (amount of $ spent, age, gender, recently visited, etc.), contact a customer via email manually, mark a customer with different labels (e.g., VIP), click into a customer's profile to see his/her information & reviews, and distinguish customers who buy in bulk with special marking, and link to Inventory Management to see which products you are holding for that customer in details.

Orders 413 can Provide:

Ability to switch between different tabs of current/completed/(other status) orders shown in list view, with sorting operations

Ability to see details of an order by clicking into it and change the status or cancel it

Notifications regarding the orders should be sent automatically to customers via email, but also allow the ability to email customer manually

Ability to search orders

When an inventory is out of stock or close to it, seller should receive alert

Ability to export the list/order detail as document

Ability to receive return/refund notice Ability to send alert to long-standing orders

Income 417 can provide:

Ability to add payment info/method to add/receive funds

Ability to set an auto-withdraw mark after a certain amount

Allow simple withdraw fund with clear action button

FIG. 4B depicts user interface screen 401B. User interface screen 401B presents user interface controls for selecting functionality available to a promoter/seller (e.g., a promoter 412). The selectable functionality includes user interface controls for choose products for others to promote 421, promote others products and earn commission 422, buy products 423, and contact support 424.

User interface screens 401A and 401B can be the interface that brands/promoters use to manage their business. In more detail, user interface screens 401A and 401B can range of business manager including:

Ability to edit My Store info (name, description, background, profile image, etc)

Ability to add a product via: a) Manual (taking pictures); b) Catalog (CSV file, XML or API which can be programmed to connect with other ecommerce stores)

Ability to add a product to promote, either choosing to promote my own products or linking to the Promote Products to promote other's products

Ability to edit products (delete, change info/price, etc)

View reviews from customers

Ability to sort products/Tip list

Ability to set shipping price

Ability to set commission and/or bulk discount on products

Ability to set up discount pricing, discount/free shipping, or other campaigns (BOGO, free sample, etc.) for a set period of time

Selecting user interface control 422 causes user interface screen 431 to be presented (FIG. 4C). As depicted, user interface screen 431 includes products 432, 433, 434, and 436 that can be promoted. Selecting product 434 causes user interface screen 441 to be presented (FIG. 4D). From screen 441, the promoter can add a tip to promote product 334. As depicted, image 442 (an image of product 434) is automatically added.

Thus, user interface screens 401A and 401B (via promote for others 422) provide the ability to Ability to pick a product from Promoter's Products and choose to either promote it via Tip or in store. When choosing promote via Tip, it can automatically turn into a Tip creation process with the product attached, for the promoter to continue adding contents, after the Tip is done, it will be automatically added to “I am promoting” tab under My Store. When choosing promote via in store presence, it will be added as a product under “Product” tab when a customer visit your Store, and under “I am selling” tab for My Store.

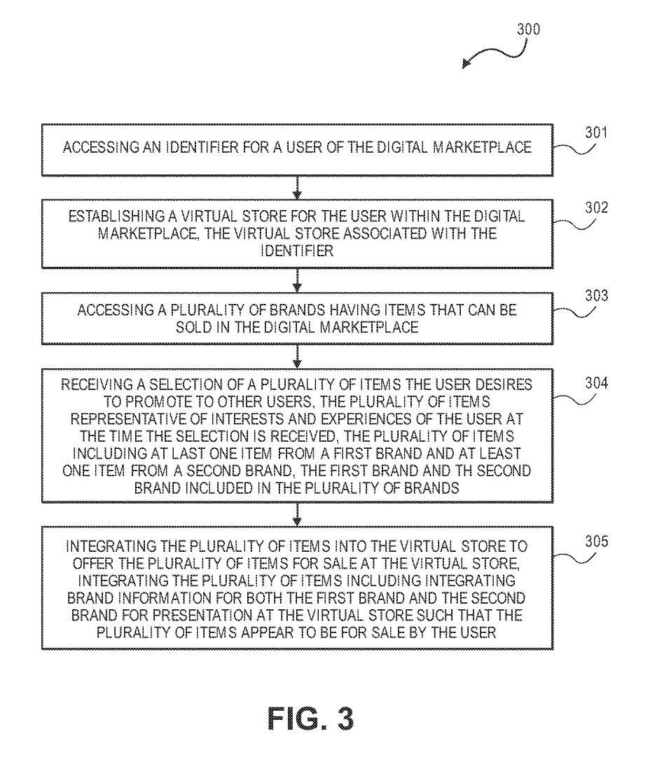

FIGS. 5A-5B depict additional user interface screens used by a promoter. Turning to FIG. 5A, FIG. 5A depicts a user interface screen 501. From user interface screen 501, a promoter can see what products they are promoting. The promoter can have reputation 503 (4.5/5) based on 35 reviewers of the promoter over the last 12 months. User interface control 502 can be selected to further promote a product via a tip. Selecting user interface control 502 causes tip screen 504 to be presented (FIG. 5B). In general, a reputation score can be based on other user's reviews and ratings of a promoter

Thus, although promoters get paid by the brands for product sales, their reputation is transparent to all users. Any consumer (other user) can write reviews and cast ratings for any promoters. Promoters need to balance the long-term interests against the potential short gain. If they don't represent the long-term interests of the consumers, they can lose followers and the ability to promote.

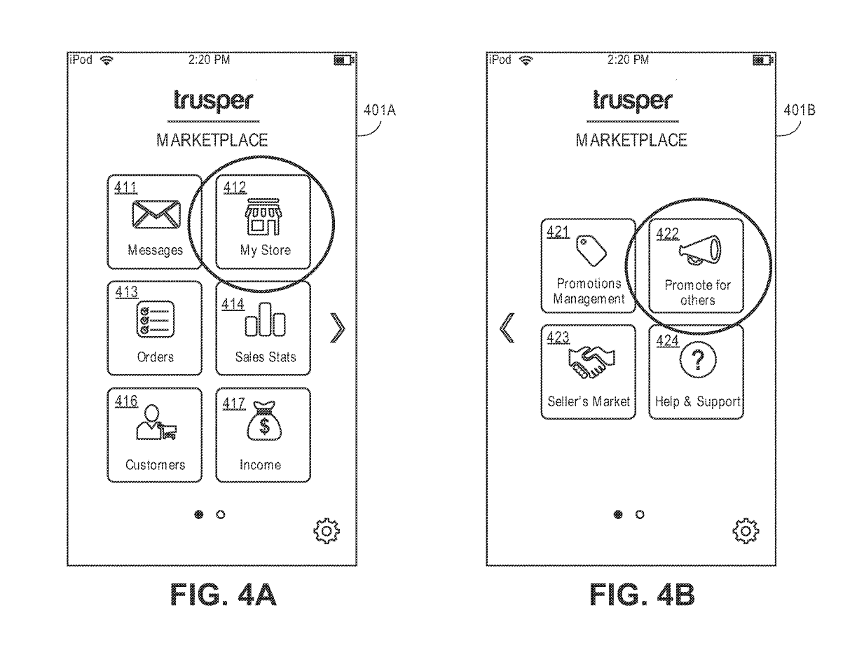

FIGS. 6A-6B depict further user interface screens used by a promoter. Turning to FIG. 6A, FIG. 6A depicts user interface screen 601. User interface screen 601 depicts a tip for a product. From user interface screen 601, a user can select “see more” 611 to see more information about the product depicted in user interface screen 601. Turning to FIG. 6B, FIG. 6B depicts user interface screen 602. User interface screen 602 shows details for the product from user interface screen 601. User interface screen 602 includes add to cart control 612 for adding the depicted product to a (e.g., universal) shopping card. User interface screen 602 also includes buy now control 613 for buying the product now. User interface screen 602 also includes go to store control 614 for going to the promoter's (e.g., Lee Ann's) store to see other products the promoter is promoting.

Thus, in general, promoters can use tips to drive product sales. Promoter tips can represent an unbiased voice providing transparency that may be lacking in other sales arrangements (e.g., Multi-Level Marketing).

In addition, promoters are not bound to one brand. Promoters can represent many brands that they personally like and enjoy using. Promoting multiple brands is possible, at least in part, due to marketplace 102 listing brands openly and competing for promoters to represent them. With a single operation (e.g., one click), a promoter can virtually display a brand or product in promoter's own store. The promoter can sell any number of units (one or 1,000 units) of a product without being forced to carry a quota. Promoters can represent any number of brands to create a virtual store that reflects the promoter's own persona or lifestyle. If a brand fails to maintain its quality or service, the promoter can simply and easily choose a different brand with a single operation.

Buyers

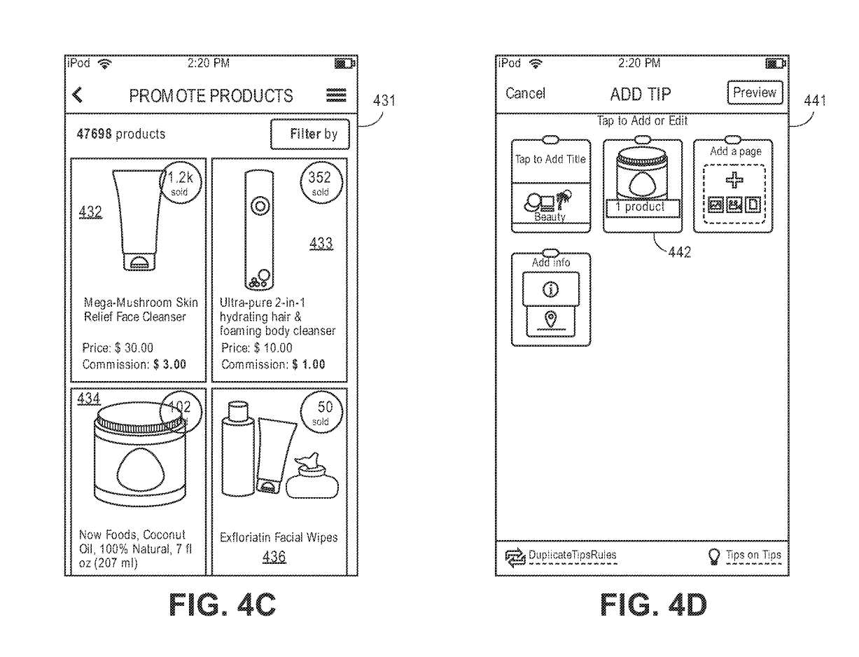

FIGS. 7A-7D depict a process flow for purchasing products from a product feed. FIG. 7A depicts user interface screen 701. User interface screen 701 presents products 704, 706, etc. available for sale at “Life-Flo's Store”. “Life-Flo's Store” can have reputation 703 (4.8/5) based on 1360 reviews over the last 12 months. Control 707 can be used to toggle between products and tips. FIG. 7B depicts user interface screen 711. User interface screen 711 presents a shopping cart for “Life-Flo's Store”. Products 712 and 713 are currently in the shopping cart. Related product 714 (not from Life-Flo's Store) is also presented. Check out control 716 can be selected by a buyer (user) to check out. FIG. 7C depicts user interface 721 (the top part of a checkout page). FIG. 7D depicts user interface 722 (the bottom part of a checkout page). After shipping/contact information and payment information is entered, a buyer can selected “place your order” control 723 to place the order for items 712 and 713.

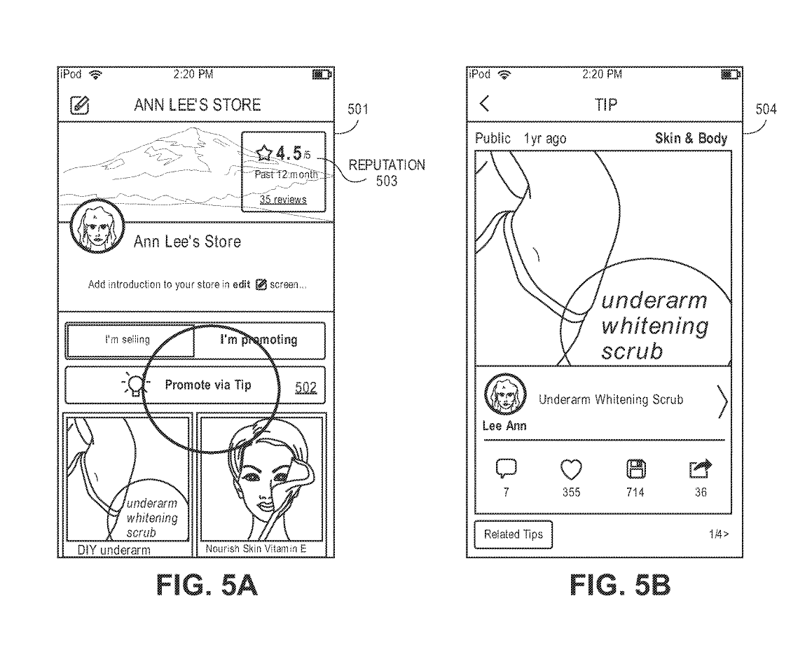

FIGS. 8A-8D depict product detail user interface screens. FIG. 8A depicts user interface screen 801. User interface screen 801 shows product details for product 802. FIG. 8B depicts user interface screen 811. User interface screen 811 shows tips 812 for product 802. User interface screen 811 also includes “go to store” control 816 for going to “Life-Flo's Store”. FIG. 8C depicts user interface screen 821. User interface screen 821 shows related products 813 related to product 802. User interface screen 821 also includes “go to store” control 816 for going to “Life-Flo's Store”. FIG. 8D depicts user interface screen 831. User interface screen 831 shows other sellers that are selling product 802. Thus, it may be that multiple promoters are promoting the same product. User interface screen 821 also includes “go to store” control 816 for going to “Life-Flo's Store”.

Prices offered by different sellers can vary based on commission, if a seller has purchased in bulk, etc.

Adding New Products

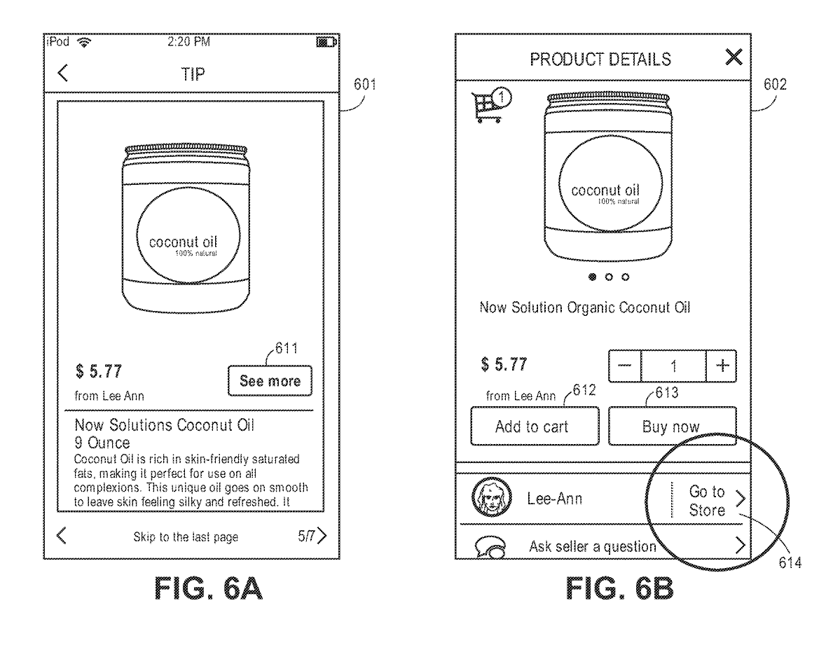

FIG. 9 depicts different ways a new product can be added. Products can be added by uploading, co-listing, or bulk-buying. Table 900 indicates options associated with different purchase methods.

Inventory

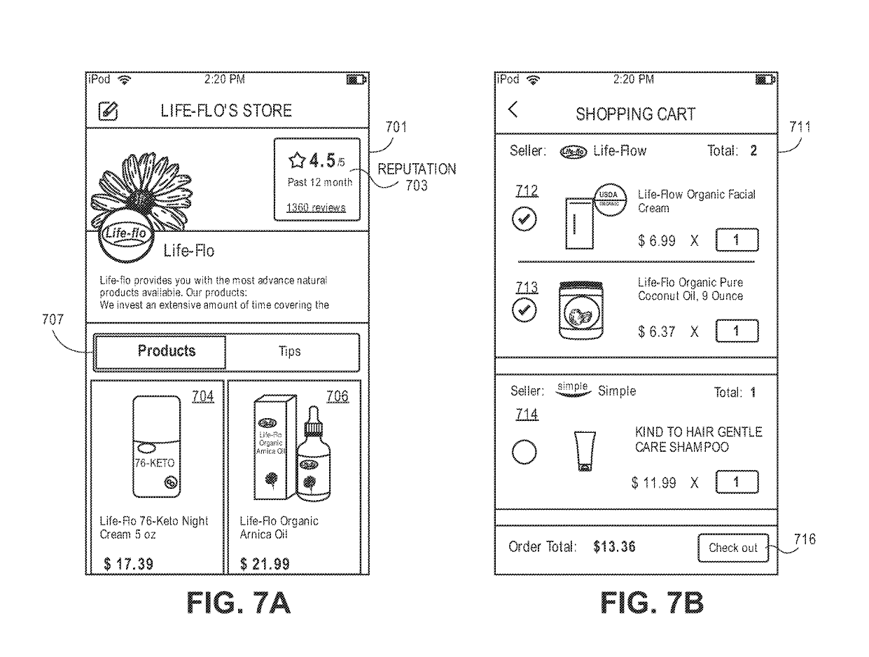

FIG. 10 depicts various inventor details in table 1000. At a user interface display, inventory can equal actual inventory minus bulk sold inventory. (When a seller buys in bulk, purchased items can be allocated specifically from the bulk sold inventory). Co-listings can share the same number of inventory with the original product uploaded. For example, a shop for one user can co-list product offered for sale in a shop for another user. When the product is sold, both inventory # of the product in S1 and S2 are updated. Inventory number can be synchronized across all co-listers.

Purchase Flows

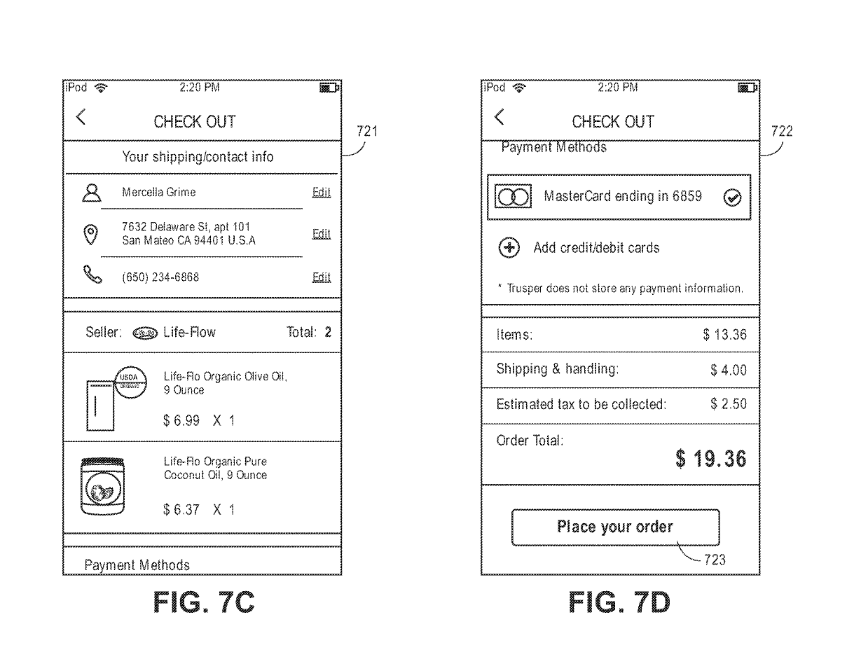

FIG. 11 depicts a purchase flow for direct purchase. Purchaser 1101 pays money for an item to shop 1102. In turn, shop 1102 ships the product to purchaser 1101.

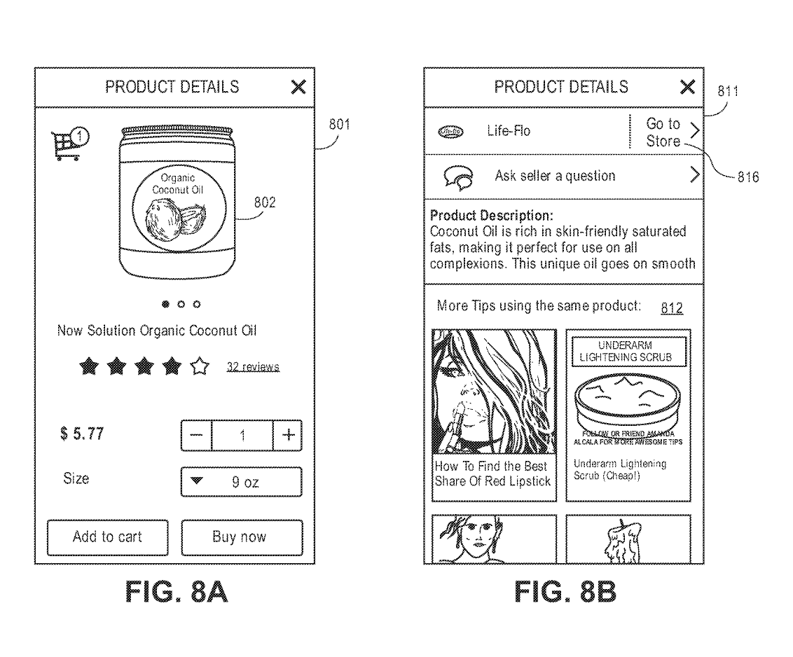

FIG. 12 depicts a purchase flow for a co-listing. Promoter 1203 co-lists a product from shop 1202. Purchaser 1201 pays money to promoter 1203 to buy the product. Promoter 1203 then pays money to shop 1202. In turn, shop 1202 ships the product to purchaser 1201.

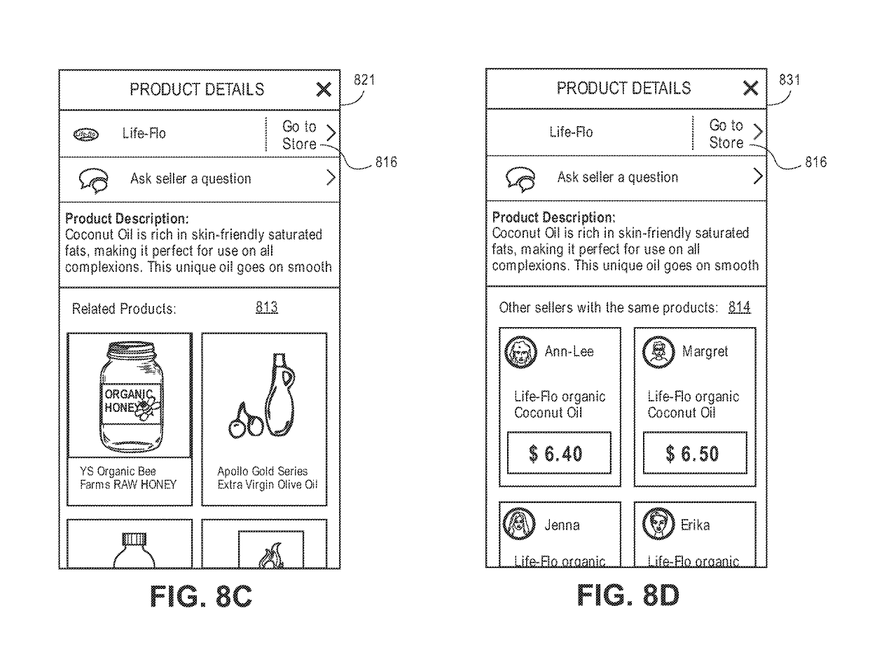

FIG. 13 depicts a purchase flow for bulk buying. Promoter 1303 pays money for a bulk quantity of a product. Purchaser 1301 pays money to promoter 1303 to buy the product. In turn, shop 1302 ships the product to purchaser 1301.

Revenue Models

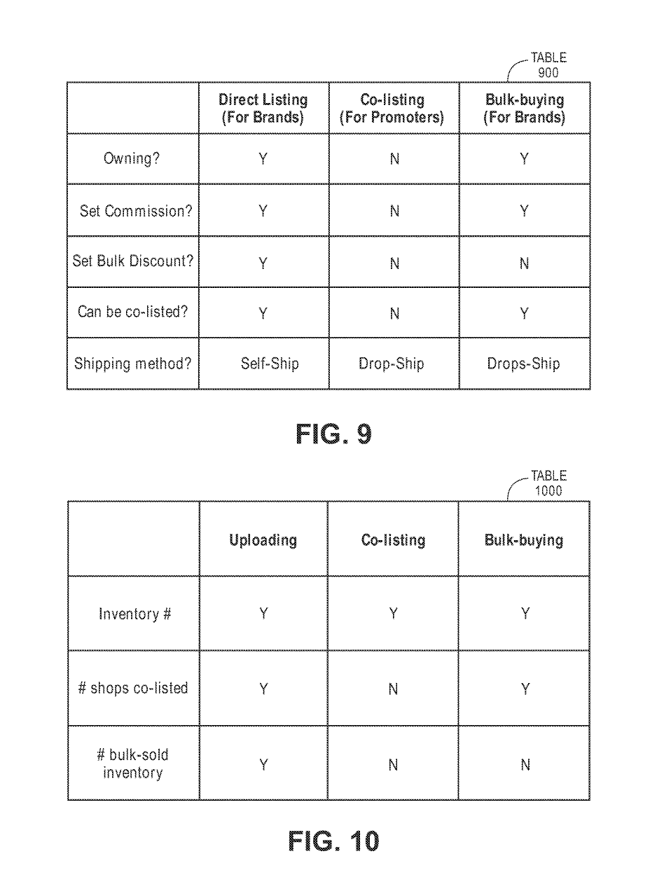

FIG. 14 depicts various different revenue models in table 1400. When the seller is a brand, the seller gets 100% revenue from direct sales, revenue minus a commission from co-listed sales, and revenue minus a discount for bulk sales. When the seller is a bulk-buyer, the seller gets a discount on direct sales and a discount minus commission on co-listed sales. When the seller is a promoter, the seller gets a commission on direct sales.

Centralized Payment System

Transactions within a social media network infrastructure can go through a centralized payment system. Purchasers can pay the centralized payment system. The centralized payment system can hold a balance for each seller (promoter). The centralized payment system can also hold an escrow account for bulk sellers.

Payment Flows

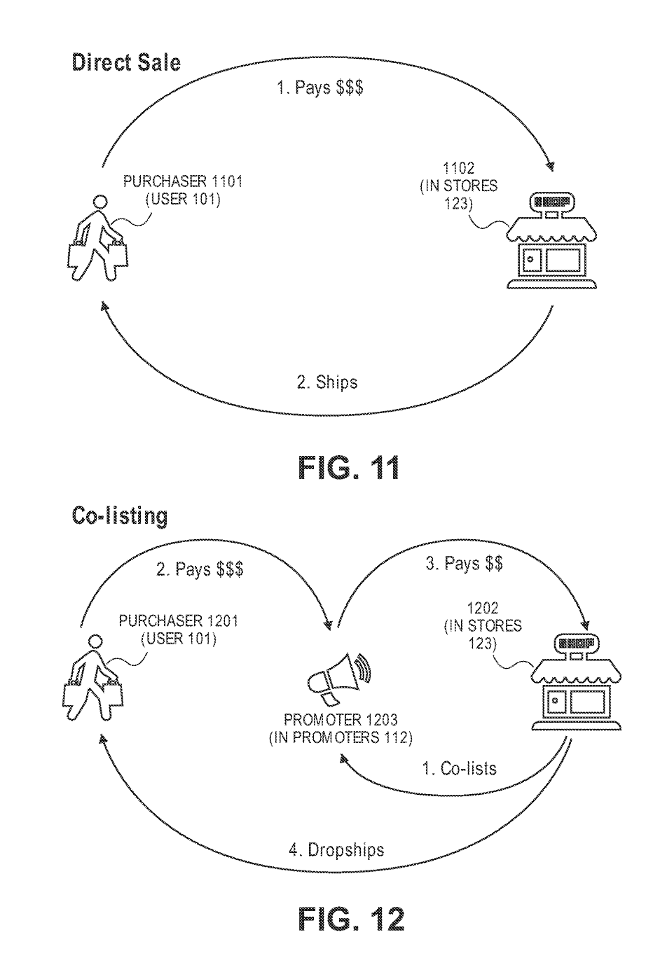

FIG. 15 depicts a payment flow for a direct purchase. Purchaser 1501 pays money to central payment system 1503. Payment system 1503 holds the money in wallet 1504. Money is withdrawn from wallet 1504 to shop 1502 for payment.

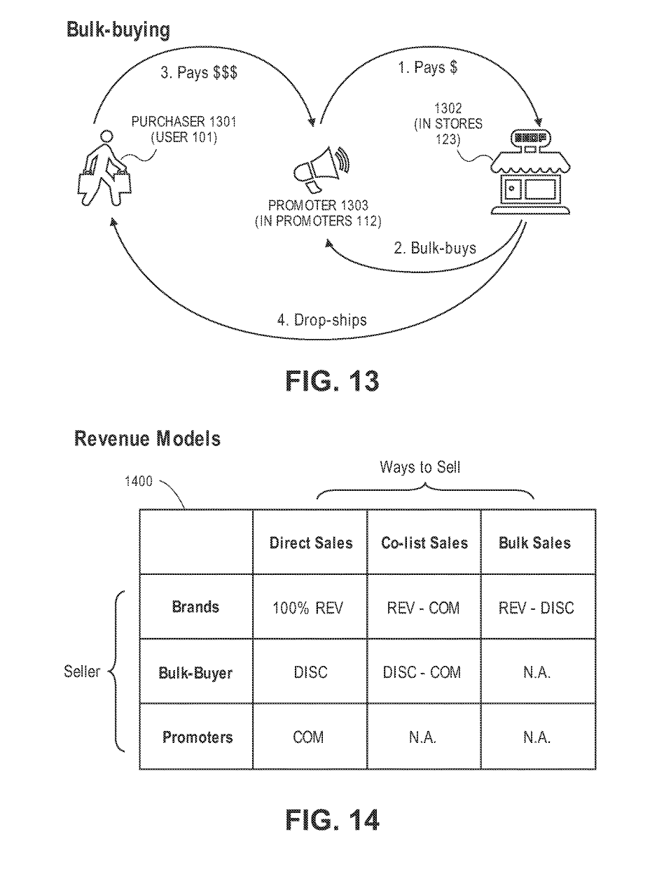

FIG. 16 depicts a payment flow for a co-listed purchase. Purchaser 1601 pays money to central payment system 1604. Payment system 1604 holds part of the money in wallet 1506 and part of the money in wallet 1607. Money is withdrawn from wallet 1606 to shop 1602 for payment. Money is withdrawn from wallet 1607 to promoter 1603 for commission.

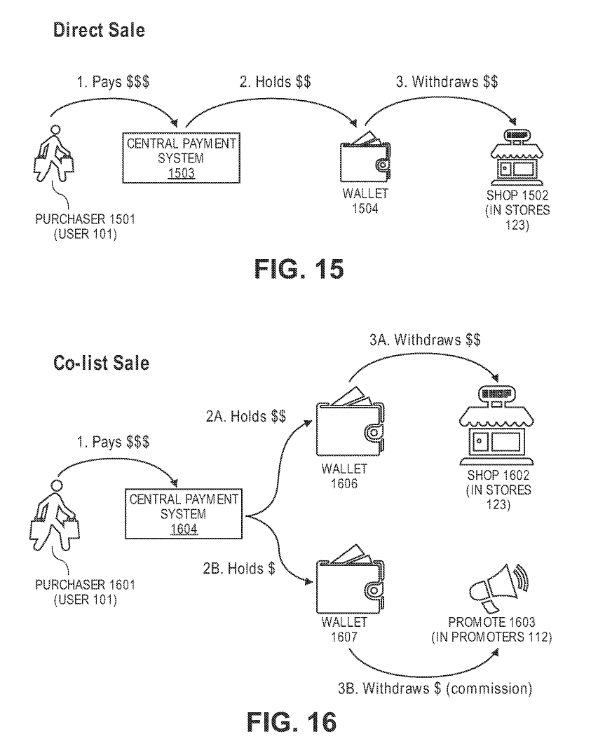

FIG. 17 depicts a payment flow for a promoter bulk-buy from brands. Promoter 1703 pays money to central payment system 1704. Central payment system 1704 transfers the money to escrow 1706 for a bulk buy from shop 1702.

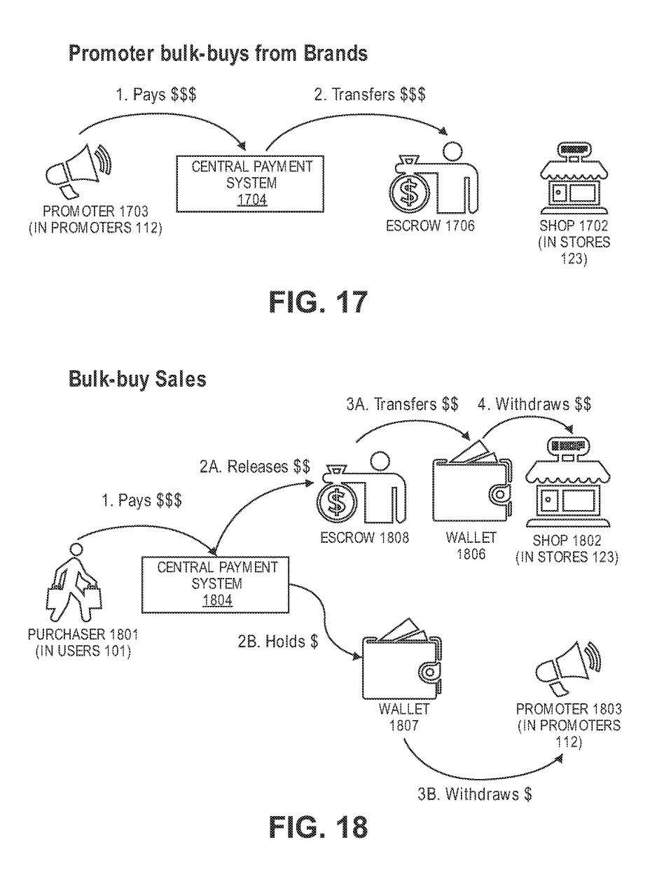

FIG. 18 depicts a payment flow for bulk-buy sales. Purchaser 1801 pays money to central payment system 1804. Central payment system releases part of the money to escrow 1808. Escrow 1808 transfers the money to wallet 1806. Shop 1802 can then withdraw the money from wallet 1806. In parallel, central payment system 1804 holds part of the money (e.g., the difference between payment from purchaser 1801 for a product and promoter 1803's purchase price for the product) in wallet 1807. Promoter 1803 can then withdraw the money form wallet 1807.

Further System Architecture

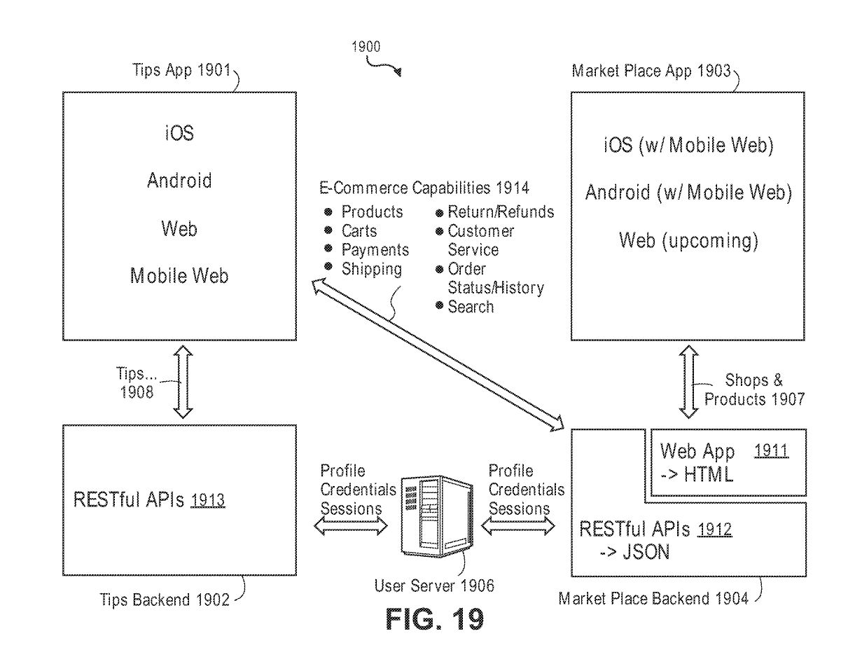

FIG. 19 illustrates an example computer architecture 1900 that facilitates providing a virtual marketplace. Each of the components depicted in computer architecture 1900 can be implemented on computer-hardware devices, in firmware, or on other circuitry. Tips 1908 can be communicated between tips application 1901 and tips backend 1902. Communication of tips can be facilitated by RESTful APIs 1913. Shops and products 1907 can be communicated between marketplace application 1903 and marketplace backend 1904. Communication of shops and products 1907 can be facilitated by Web application 1911. E-commerce capabilities 1914 can be provided from marketplace backend 1904 to tips application 1901. Providing e-commerce capabilities 1914 can be facilitated by RESTful APIs 1912. User server 1906 can establish profile credentials sessions with tips backend 1902 and market place backend 1904 (to tie together authorized communication between tips backend 1902 and market place backend 1904).

Tips application 1901 and marketplace application 1903 are customer facing. As such, tips application 1901 and marketplace application 1903 can be included in marketplace tier 102. Tips backend 1902 and marketplace backend 1904 can be included in merchant manager tier 104.

Implementation in Trusted Social Network

In some aspects, a trusted social media network system or infrastructure includes a match engine, a tip database, an ad bid system, a market place system, and a member database. The match engine can be used to match ads, offers, and jobs to tips and advice to provide to friends. The match engine can consider input from the tip database and input from the member database when matching ads, offers, and jobs to tips and advice.

Experts can post ads, offers, and jobs which the match engine can be attempt to match to members of the trusted social network. Experts can also submit ads to the ad bid system.

Tips stored in the tip database can be associated with various types of metadata including a tip owner, a tip editor, a value, categories of interest, sub-categories of interest, etc. Tips can be categorized from samples tips. The sample tips can be used as templates for actual tips.

Members in the member database can also be associated with various types of metadata including member interest, categories of interest, sub-categories of interest, points, status, leader board, and user behavior with respect to tips, such as, for example, read, add, search, and like. Members can be added to the member database from other social networks and contact lists.

Members can use an application on their computer or phone to create and edit tips as well as view tips from other members. Members can also use an application to invite other members to be friends and to follow other members.

In general, a tip is a generic informational unit that users create, store, share, use and search for. A tip can include a list of media assets (photos, video, audio and other media types), textual/audio/music captions about the media assets, a list of reference info and contact info. Users can use a smart phone, pad or PC to create these tips quickly (typically within a few minutes). As described, tips can be stored in the tip database (e.g., in the cloud) for reuse, sharing and archiving.

Tips can be organized into different “Topics” including Arts, Auto, Business, Entertainment, Family, Fashion & Beauty, Food & Drink, For Hire, Games, Help Wanted, Home & Garden, Offers & Deals, Pets, Sports, Technology, Travel, as well as individually defined categories and “Everything”. Each Topic is made of a list of “Interests”. For example, “Sports” is made of “Football”, “Golf”, “Tennis”, “Baseball” and others. Topics are also called Categories and Interests are also referred as Sub-Categories. The system maintains a much larger set of categories/sub-category keywords than what users see. If users have preferences on certain keywords or terms, these keywords can become more visible to users, and less used keywords can be suppressed.

Anyone can sign up to be a member of the trusted social network. Consumer members can use the trusted social network to 1) store their personal and private tips for future reference, 2) share their life learning/tidbits with their friends, and 3) publish their proud moments/knowledge to the public. Business members can use the trusted social network to connect with their customers, promote their services (offers, coupons, deals etc.). Both consumers and businesses can use the system to hire professionals or employees for projects or jobs.

Users can earn points of achievement by publishing good tips. The owner of the trusted social network and the creator jointly own tips. If money changes hands on or about the tips, the creator can get royalty fees or other benefits.

The number of users on the trusted social network can grow exponentially via a “Word of Action” viral model through three different factors: 1) the App naturally involves other users without telling friends how wonderful the new App is. Sharing a tip with 4 friends causes natural actions for the friends to download the App in order to see the tip without anyone to explicitly promote the App. So the network size can grow from 1 to 4 to 16 users when each user decide to create and share their tips to 4 new friends of their own; 2) the virality is also heavily influenced by the frequency of the actions. If tips are shared daily or weekly, the network effect multiplier is daily or weekly. So it won't take much time to cover the entire population. For example, if the App is used weekly with each user adding 4 new users to the network without any degradation in the process, it takes only 4 months (1->5->25->125 . . . ->2M at 9 weeks . . . ->1B at 3 months . . . ->6B at 4 months) to populate the whole world; 3) the 3^{rd} factor of virality has to do with the trust factor in order to get new users involved (the 4 new users in the example above) without too much degradation. Good friends can get us to take actions (such as viewing a tip) better than strangers. So apps getting friends to do things together have a better virality than apps for public users.

The trusted social network generates a social graph that is ultimately more interesting because it is based on the “Word of Actions” and frequent usage (daily or weekly). The social graph together with a unique interests graph helps to make the trusted social network more effective in serving content and promotions in the form of tips.

User behaviors are tracked in the trusted social network including both express and implicit behaviors. Express behaviors include purchasing, reviewing, promoting, rating, liking, commenting, sharing, reposting, saving, etc. Implicit behaviors include clicking, viewing, swiping, enlarging, dwell time, flipping to the backside, viewing comments, viewing related/popular/nearby/ . . . , calling, mapping, emailing, chatting, geo-location, etc. By combining these behaviors and the categories/topics/interests, individual user interest's graph can be derived for members. By correlating multiple users' interest's graphs, peer interests graphs or crowd interest graphs can be generated.

By factoring both social graph and interests graphs of members, the trusted social network can predict (relatively accurately) the content/tips that members would like to consume at a given moment. Related tips are displayed to members by weighing social norms, contexts, location and historical interests. The match engine can dynamically weigh in these factors and changes the outcome what users see. The match engine can observe, learn and adapt.

Promotional tips can be presented to users in the category of promotions such as “Offers & Deals”, “For Hire”, “Help Wanted”, etc. These tips can be ranked by popularity, location and a user's social interests to them. For example, if a friend of mine Joe likes a coupon from a restaurant, the coupon will be ranked higher to me than to someone who is not a friend of Joe. As a result, the match engine can promote ads without offending users.

Businesses also get exposure of their offers/tips by having friends to push their tips at the right place and right time, or by having a large set of followers. In addition, businesses can buy ad placement in related tips or popular tips. Through the ad bid system, business can bid with each other on the pricing of certain spots, with ads being low to start with. Ad placement bidding is similar to the web keyword bidding except that the bidding is for related tips in a non-social-graph connected space.

Special tip templates can be created for business purpose. The templates allow business owners to create business Tips very quickly and in real-time to promote their business. For example, an “Offers and Deals” tip can allows consumers to pass around the tip by reposting and sharing them (via the App, Facebook, Email, SMS etc.). A “redeem” button is built in to allow consumers to follow the business in the future. For example, a neighborhood restaurant has only accumulated 300 customer emails in 15 years. It is very hard for them to get the word out to their customers. Now with the coupon redemption action on the App, the restaurant can get up to 2500 diners per week to follow them. In a year, they will be able to contact 10,000's of patrons with these real-time coupons and daily specials on demand. The restaurant owners or managers can change their coupons several times a day in a few minutes directly.

Consumers get a huge benefit from this as well. A typical family goes out to eat multiple times a week with a choice of 10-20 restaurants in the neighborhood. Often time, the decision of what and where to eat is not decided until you are in a car. With the App, the consumers can use “find deals nearby” to help the decision process. The same phenomenon is also true for business lunch on daily basis.

Similar templates are created to support “For Hire” and “Help Wanted” tips. Service professionals like gardeners, pool man, etc. can get referrals directly from their existing customers. Bars and restaurants can post their jobs with tips and get applicants directly via video and pictures on the candidates instead of a form or resume.

The user application for the trusted social network can use GPS to locate and connect friends nearby. This is a quick way to connect with friends beyond the traditional connections via Facebook, Email, Contact List etc. When you are in a party with dozens of friends, people can install the App and connect with others in a matter of 30 seconds.

User-Interface

A variety of different user-interfaces (including those already described) can be used at a client application to give a member access to a trusted social network. User-interfaces can integrate data from a variety of different sources to more efficiently present a virtual marketplace to a user. For example, a user-interface can include controls for integrating tip and marketplace information from varied and diverse computer hardware within a network. Thus, aspects of the invention address a business challenge that is particular to networks in general, and more particularly to the Internet. Aspects of the invention are rooted in computer technology in order to overcome a problem specifically arising in the realm of computer networks. For example, aspects of the invention address the problem of how to seamlessly present tips and marketplace information from a promoter to a user when marketplace (e.g., brand and/or product) information and/or tips are accessed from a variety of different machines on a network. A product can appear for sale in a promoters store even though the product is co-listed with other promoters or even co-listed by the brand owner.

Products can be purchased through product detail pages or through shoppable tips that integrate a tip into a check out mechanism.

Client Application API

Various APIs can be used by a client application to facilitate access to a trusted social network.

Although the components and modules illustrated herein are shown and described in a particular arrangement, the arrangement of components and modules may be altered to process data in a different manner. In other aspects, one or more additional components or modules may be added to the described systems, and one or more components or modules may be removed from the described systems. Alternate implementations may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate implementations may be used in any combination desired to form additional hybrid implementations of the invention.

Further, although specific aspects of the invention have been described and illustrated, the invention is not to be limited to the specific forms or arrangements of parts so described and illustrated.

The present invention may be implemented in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A processor implemented method for creating a virtual store within a digital marketplace, the processor implemented method comprising:
receiving an identifier for a user of the digital marketplace;
establishing a virtual store for the user within the digital marketplace, the virtual store associated with the identifier;
accessing a plurality of brands having items that can be sold in the digital marketplace;
receiving a selection of a plurality of items the user desires to promote to other users, the plurality of items representative of interests and experiences of the user at the time the selection is received, the plurality of items including at least one item from a first brand and at least one item from a second brand, the first brand and the second brand included in the plurality of brands; and
integrating the plurality of items into the virtual store to offer the plurality of items for sale at the virtual store, integrating the plurality of items including integrating brand information for both the first brand and the second brand for presentation at the virtual store such that the plurality of items appear to be for sale by the user.

2. The method of claim 1, further comprising providing a link to a user generated tip for at least one item for sale in the virtual store, the user generated tip generated by the user.

3. The method of claim 1, further comprising providing a reputation score for the user within the virtual store such that other users can judge the reputation of the user.

4. The method of claim 1, further comprising subsequent to integrating the plurality of items into the virtual store:
receiving a further selection of at least one additional item the user desires to promote to other users, the at least one additional item representative of interests and experiences of the user at the time the further selection is received;
receiving input selecting at least one item in the plurality of items for removal from the virtual store, the at least one item selected for removal no longer representative of interests and experiences of the user at the time the input is received; and
adjusting items offered for sale through the virtual store, including:
integrating the at least one additional item into the virtual store to offer the at least one additional item for sale at the virtual store; and
removing the at least one item from the virtual store.

5. The method of claim 4, wherein the at least one additional item is from a third brand, the third brand included in the plurality of brands, the third brand different from the first brand and the second brand.

6. The method of claim 4, further comprising:
receiving a user login to a social media network; and
establishing a social media network session for the user within the social media network; and
wherein integrating the plurality of items into the virtual store to offer the plurality of items for sale at the virtual store comprises integrating the plurality of items into the virtual store during the social media network session; and
wherein adjusting items offered for sale through the virtual store comprises adjusting items offered for sale through the virtual store during the social media network session.

7. The method of claim 1, wherein integrating the plurality of items into the virtual store to offer the plurality of items for sale at the virtual store comprises offering the plurality of items for sale on consignment.

8. The method of claim 7, further comprising:
receiving an order that another user of the digital marketplace has purchased an item from the virtual store; and
notifying a brand associated with the purchased item to fulfill the order by shipping the item to the other user, the notified brand included in the plurality of brands.

9. The method of claim 8, further comprising:
receiving funds used to purchase the item; and
distributing the received funds between a digital wallet for the user and a digital wallet for the brand in accordance with defined rules.

10. The method of claim 1, wherein integrating the plurality of items into the virtual store to offer the plurality of items for sale at the virtual store comprises integrating the plurality of items into a micro store.

11. A processor implemented method for operating a virtual store within a digital marketplace, the processor implemented method comprising:
receiving a user selection of a link to a virtual store, the virtual store for a promoter that is promoting a plurality of products, including promoting one or more products from each of a plurality of different brands;
accessing store data for the virtual store;
processing the store data to present the virtual store to the user in response to the user selection, including presenting the plurality of products for sale;
receiving an order for a product, from among the plurality of products, that the user desires to purchase from the virtual store, the product corresponding to a brand from among the plurality of brands;
in response to the purchase selection, starting a purchase flow for the product, including instructing the brand to fulfill the order by shipping the product to the user; and
using a centralized payment system of the digital marketplace to pay a commission for sale of the product to the promoter.

12. The method of claim 11, further comprising, prior to receiving the user selection of the link to the virtual store, presenting a shoppable tip for the product to the user; and
wherein receiving a user selection of a link to a virtual store comprises receiving a selection of a link corresponding to the shoppable tip.

13. The method of claim 11, wherein processing the store data to present the virtual store to the user in response to the user selection comprises presenting the product along with one or more tips for the product at the virtual store.

14. The method of claim 11, wherein processing the store data to present the virtual store to the user in response to the user selection comprises presenting a reputation score for the promoter, the reputation score based other user's reviews and ratings of the promoter.

15. The method of claim 11, wherein processing the store data to present the virtual store to the user in response to the user selection comprises presenting a reputation score for each of the plurality of brands, the reputation score for each brand based user's reviews and ratings of the brand.

16. The method of claim 11, wherein the virtual store is a micro store.

17. A system for managing a digital marketplace, the system comprising:
one or more processors;
system memory;
one or more computer storage devices having stored thereon computer-executable instructions for managing a virtual store for a user of the digital marketplace, including for each user:
receiving a selection of a plurality of items the user desires to promote to other users, the plurality of items representative of interests and experiences of the user at the time the selection is received, the plurality of items including at least one item from a first brand and at least one it from a second brand, the first brand and the second brand included in the plurality of brands;
integrating the plurality of items into the virtual store to offer the plurality of items for sale at the virtual store, integrating the plurality of items including integrating brand information for both the first brand and the second brand for presentation at the virtual store such that the plurality of items appear to be for sale by the user;
subsequent to integrating the plurality of items:
receiving an order for item, from among the plurality of items, that a second user desires to purchase from the virtual store, the items corresponding to a brand from among one of: the first brand and the second brand;
in response to the purchase selection, starting a purchase flow for the item, including instructing the brand to fulfill the order by shipping the item to the second user; and
using a centralized payment system within the digital marketplace to pay a commission for sale of the product to the user.

18. The system of claim 17, wherein receiving an order for the item comprises receiving selection of a link included in a shoppable tip associated with the item, the shoppable tip created by the user.

19. The system of claim 17, further comprising:
presenting a reputation score for the user in a user interface of the virtual store; and
presenting a reputation score for each of the first brand and the second brand in the user interface of the virtual store.

20. The system of claim 17, wherein the virtual store is a micro store.
